(19) United States
(12) Patent Application Publication
(10) Pub. No.: US 2024/0302653 A1
(43) Pub. Date: Sep. 12, 2024

(54) ABERRATION CORRECTED OPTICAL ASSEMBLY

(71) Applicant: UNIVERSITY OF FLORIDA RESEARCH FOUNDATION, INCORPORATED, Gainesville, FL (US)

(72) Inventor: James STROTHER, Gainesville, FL (US)

(21) Appl. No.: 18/264,605

(22) PCT Filed: Mar. 8, 2022
(86) PCT No.: PCT/US2022/019279

§ 371 Date: Aug. 8, 2023

Related U.S. Application Data
(60) Provisional application No. 63/159,626, filed on Mar. 11, 2021.

(51) Int. Cl. G02B 27/00; G02B 26/08; G02B 26/10

(52) U.S. Cl. CPC G02B 27/0031; G02B 26/0825; G02B 26/0875; G02B 26/10; G02B 27/005

(57) ABSTRACT

Tunable optical assemblies and/or optical systems comprising such tunable optical assemblies that are corrected, at least to first order, for tuning-induced and/or tuning-independent spherical and chromatic aberrations. In an example embodiment, a tunable optical assembly comprises a tunable lens; and an intermediate focal plane defining (IFPD) objective. The IFPD objective is disposed upstream of the tunable lens in the tunable optical assembly and is configured to define an intermediate focal plane disposed between the IFPD objective and the tunable lens. In an example embodiment, the IFPD objective is an air objective.

### CROSS-REFERENCE TO RELATED APPLICATIONS

This application claims priority to U.S. Application No. 63/159,626, filed Mar. 11, 2021, the content of which is hereby incorporated by reference in its entirety herein.

### BACKGROUND

In various scenarios it may be desirable to capture a magnified three-dimensional optical image of a sample. Multiple approaches have been explored for performing volumetric microscopic imaging. However, a number of such approaches take a considerable amount of time to scan through different depths of a sample volume. Changes in the power of a varifocal lens in the optical assembly of an optical system can produce rapid movement in the focal position while maintaining the microscope objective (e.g., the primary magnifying lens and/or lens assembly) at a fixed position. Thus, uses of varifocal lenses may provide a technical solution to the technical problem of performing fast axial scanning of a sample volume. However, varifocal lenses introduce a significant amount of tuning-induced spherical aberration into the resulting image(s).

### BRIEF SUMMARY OF THE INVENTION

Various embodiments provide technical solutions to the technical problem of the aberrations introduced into an optical assembly or optical system comprising the optical assembly by the inclusion of a varifocal lens in the optical assembly. Various embodiments provide tunable optical assemblies or optical systems comprising an embodiment of a tunable optical assembly that eliminate effects of first order tuning-induced spherical aberration on images captured via the tunable optical assemblies and/or by the optical systems. In various embodiments, the tunable optical assembly is configured to correct for first order tuning-induced spherical aberration by having an intermediate focal plane adjacent to the tunable lens surface with a prescribed magnification. For example, in various embodiments, the tunable optical assembly comprises a tunable lens and an intermediate focal plane defining (IFPD) objective, such as an air objective. The IFPD objective is upstream of the tunable lens in the optical path of the optical assembly and is configured to define an intermediate focal plane between the IFPD objective and the tunable lens. In an example embodiment, the IFPD objective is configured to define an intermediate focal plane between the air objective and the tunable lens upon which an intermediate image having a prescribed magnification is formed when the optical assembly is used to image a sample volume. For example, the air objective may have a prescribed magnification. In various embodiments, the prescribed magnification is in the range of 2 to 4 times (e.g., approximately 2.95×). In various embodiments, a relay lens and/or lens assembly may be used after the tunable lens to correct for aberrations in the intermediate image.

For example, various embodiments provide a tunable optical assembly comprising a tunable lens; and an IFPD objective. The IFPD objective is disposed upstream of the tunable lens in the tunable optical assembly and is configured to define an intermediate focal plane disposed between the IFPD objective and the tunable lens. In an example embodiment, the IFPD objective is an air objective and/or has a magnification in a range of four to two times.

In an example embodiment, the tunable optical assembly further comprises a first tube lens; and a second tube lens, the first tube lens being upstream of the second tube lens in the tunable optical assembly and the second tube lens being upstream of the IFPD objective in the tunable optical assembly. In an example embodiment, the first tube lens forms an intermediate image between the first tube lens and the second tube lens. In an example embodiment, changing of the focal length of the tunable lens causes the intermediate image to shift images between the first tube lens and second tube lens and the first tube lens and second tube lens are configured such that the intermediate image is not formed within either of the first tube lens or the second tube lens. In an example embodiment, at least one of the first tube lens or second tube lens defines a pupil between the second tube lens and the IFPD objective. In an example embodiment, the tunable optical assembly further comprises a deformable mirror adaptive optics element disposed at the pupil. In an example embodiment, the deformable mirror adaptive optics element is configured to compensate for wavefront aberrations introduced by at least one of a sample object or the tunable lens.

In an example embodiment, the tunable optical assembly further comprises a relay lens disposed downstream of the tunable lens. In an example embodiment, the relay lens is configured to correct at least one of tuning-independent coma or chromatic aberration of the tunable optical assembly. In an example embodiment, the tunable optical assembly comprises at least one of an optical sensor or an view port. In an example embodiment, the optical sensor is at least one of a camera, CCD sensor, or CMOS sensor. In an example embodiment, the at least one of an optical sensor or view port is disposed at an imaging plane defined by the relay lens. In an example embodiment, the relay lens is an assembly comprising a plurality of lenses.

Various embodiments provide an optical system comprising an embodiment of the tunable optical assembly. In an example embodiment, the optical system further comprises a tunable lens driver configured to control the focal length of the tunable lens. In an example embodiment, the focal length of the tunable lens is configured to be adjusted to axially scan through a sample volume. In an example embodiment, an optical sensor located at the imaging plane of the optical assembly is in communication with at least one processing element. In an example embodiment, the processing element is configured to control the tunable lens driver. In an example embodiment, the optical system is an axial-scanning microscope system or an axial-scanning telescope system.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example tunable optical assembly, according to an example embodiment.

FIG. 2 provides a schematic diagram of a tunable lens, according to an example embodiment.

FIG. 3 provides a schematic of an IFPD objective, according to an example embodiment.

FIG. 4 provides a schematic diagram of a first tube lens, according to an example embodiment.

FIG. 5 provides a schematic diagram of a second tube lens, according to an example embodiment.

FIG. 6 provides a schematic of a relay lens assembly, according to an example embodiment.

FIG. 7 provides block diagram of an optical system comprising a tunable optical assembly, according to an example embodiment.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. As used herein, the terms “substantially” and “approximately” refer to within the appropriate manufacturing and/or engineering tolerances and/or user measurement capabilities. Like numbers refer to like elements throughout.

### Exemplary Tunable Optical Assembly

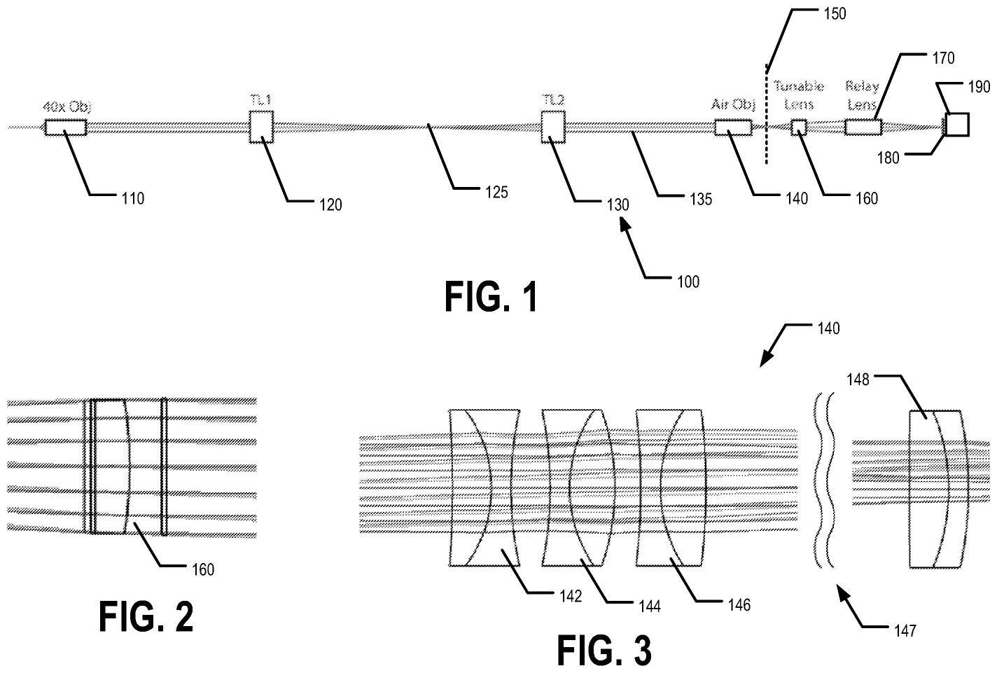

Various embodiments provide a tunable optical assembly that is configured to correct, at least to first order, first order tuning-induced spherical aberration spherical aberrations. FIG. 1 illustrates an example embodiment of a tunable optical assembly 100 of an example embodiment. In various embodiments, the tunable optical assembly 100 further comprises tunable lens 160. In various embodiments, the tunable lens 160 is a lens that may have its focal length changed (e.g., by application of a voltage to the tunable lens 160, and/or the like). For example, the focal length of the tunable lens 160 is tunable. In an example embodiment, the tunable lens 160 is a tunable acoustic gradient lens. In various embodiments, various tunable lenses may be used. FIG. 2 provides a ray diagram of a tunable lens 160, according to an example embodiment. In an example embodiment, the tunable lens 160 is a tunable aspherical lens. In an example embodiment, the tunable lens 160 is a tunable spherical lens. In various embodiments, the tunable lens 160 is located at a pupil of the optical path of the tunable optical assembly 100. For example, an intermediate focal plane defining (IFPD) objective 140 and/or the second tube lens 130 may form a pupil downstream of the IFPD objective 140 at which the tunable lens 160 is positioned.

In various embodiments, the tunable optical assembly 100 further comprises an IFPD objective 140. In an example embodiment, the IFPD objective 140 is an air objective. In an example embodiment, an air objective is a lens assembly that forms an intermediate image in an air space. In various embodiments, the IFPD objective 140 is configured to define an intermediate focal plane 150 between the IFPD objective 140 and the tunable lens 160. In various embodiments, the intermediate focal plane 150 is a real focal plane. In an example embodiment, the intermediate focal plane 150 is a virtual focal plane. In an example embodiment, the IFPD objective 140 is configured to generate a real or virtual intermediate focal plane 150 between the second tube lens 130 and the relay lens 170. As should be understood by one of ordinary skill in the art, a real image plane is a plane corresponding to the collection of focus points from converging rays and a virtual image plane is a plane corresponding to the collection of focus points made by extensions of diverging rays (e.g., traced backward through a corresponding optical component).

In an example embodiment, the IFPD objective 140 is configured to generate the intermediate focal plane 150 at a distance from the tunable lens 160 such that the beam of light traversing the optical path of the tunable optical assembly 100 substantially fills the usable aperture of the tunable lens 160. In an example embodiment, the distance between the intermediate focal plane 150 and the tunable lens is an approximately maximum distance for which all of the beam of light traversing the optical path of the tunable optical assembly 100 is incident the tunable lens 160 (e.g., not clipped by the tunable lens 160). Such a configuration may enable the axial scanning range of the tunable optical assembly 100 to be maximized. In an example embodiment, the distance between the intermediate focal plane 150 and the tunable lens 160 affects the magnitude of the coma required of the optical path upstream of the tunable lens 160.

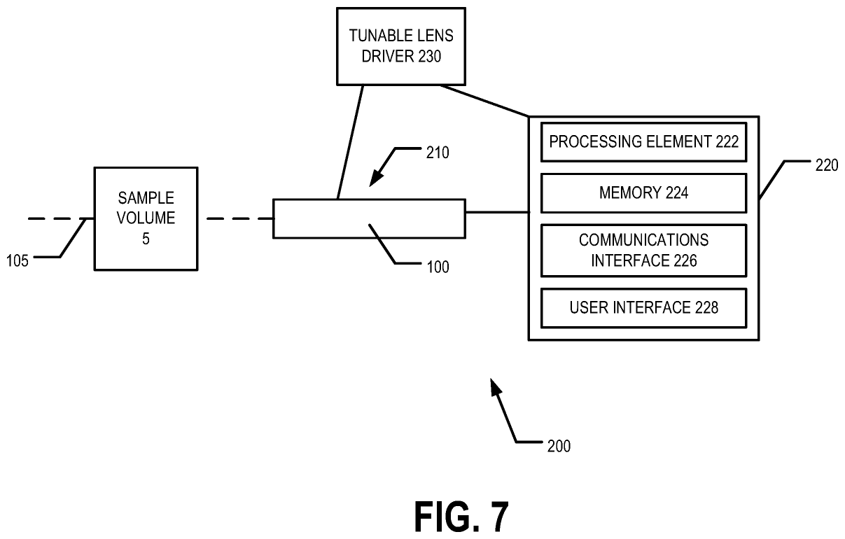

In an example embodiment, the IFPD objective 140 has a prescribed magnification. For example, the IFPD objective 140 is configured to generate an intermediate image at the intermediate focal plane 150 having a prescribed magnification (e.g., with respect to a sample located within a sample volume 5, shown in FIG. 7). In an example embodiment, the intermediate focal plane 150 is closer to the IFPD objective 140 than to the tunable lens 160. In various embodiments, the prescribed magnification is in the range of 5× to 1×. In various embodiments, the prescribed magnification is in the range of 4× to 2×. In various embodiments, the prescribed magnification is in the range of 3.1× to 2.9×. For example, in an example embodiment, the prescribed magnification is approximately 2.95×.

In various embodiments, the IFPD objective 140 is configured to correct the tuning-induced axial chromatic aberration by introducing a lateral chromatic aberration into the pupil image space (e.g., the conjugate space) of the tunable optical assembly 100 that cancels out and/or counteracts the tuning-induced axial chromatic aberration introduced into the optical path of the tunable optical assembly 100 by the tunable lens 160.

FIG. 3 provides a schematic diagram of an example IFPD objective 140 that is an air objective. In the illustrated embodiment, the IFPD objective 140 comprises a positive group 142 in which the positive element is a flint glass, a group 144 containing a negative element that is a flint glass with anomalous partial dispersion, and a lens group 146 comprising lenses with similar refractive indices but different abbe numbers that correct for higher order aberrations, a long air space 147 (e.g., 50-300 mm along the optical path of the tunable optical assembly 100), and a positive group 148 in which the positive element is a crown glass, from upstream to downstream of the optical path.

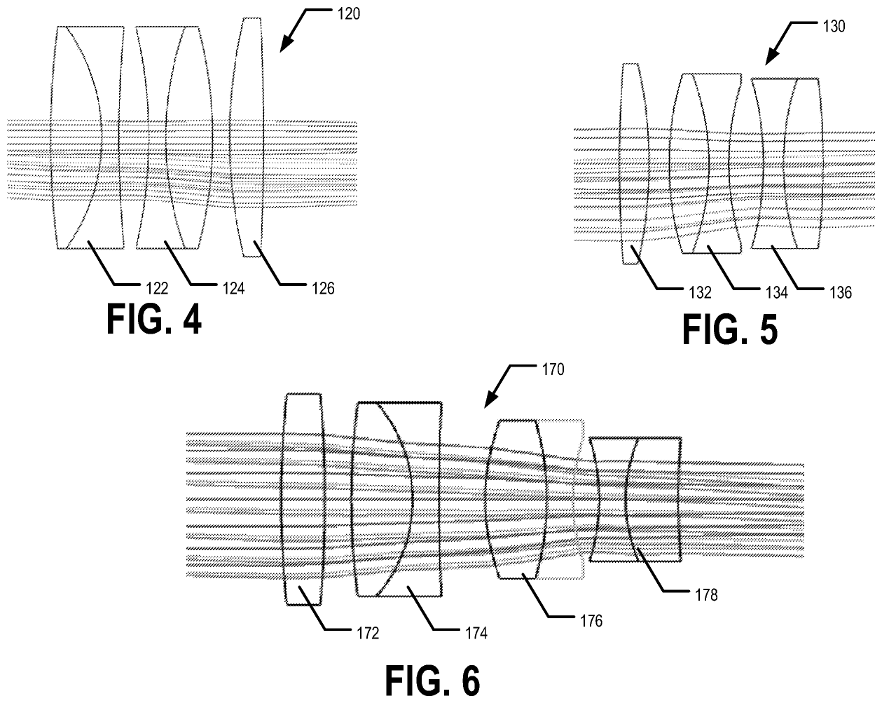

In various embodiments, as shown in FIG. 1, the tunable optical assembly 100 comprises a first tube lens 120 and second tube lens 130. In various embodiments, the first tube lens 120 is upstream of the second tube lens 130 and the second tube lens 130 is upstream of the IFPD objective 140, with respect to the optical path of the tunable optical assembly 100. FIG. 4 provides a schematic view of an example first tube lens 120, according to an example embodiment. In the illustrated embodiment, the first tube lens 120 comprises a doublet 122 comprising a positive element made from flint glass and a negative element made from flint glass with anomalous partial dispersion, a doublet 124 comprising a negative element made from flint glass and a positive element made from crown glass, and a positive singlet 126, from upstream to downstream of the optical path of the tunable optical assembly 100. FIG. 5 provides a schematic view of an example second tube lens 130, according to an example embodiment. In the illustrated embodiment, the second tube lens comprises a positive singlet 132, a doublet 134 comprising two glasses with anomalous partial dispersion, and a doublet 136 comprising a negative element made from flint glass with anomalous partial dispersion and a positive element made from flint glass, from upstream to downstream of the optical path of the tunable optical assembly 100.

In various embodiments, the first tube lens 120 is configured to form a mobile image 125 between the first tube lens 120 and the second tube lens 130. In various embodiments, the first tube lens 120 and/or the second tube lens 130 is a five element, three group lens assembly. When the focal length of the tunable lens 160 is changed, tuned, and/or adjusted, the location and/or position of the mobile image 125 shifts. In various embodiments, the first tube lens 120 and the second tube lens 130 are configured such that the mobile image 125 is always formed between the first tube lens 120 and second tube lens 130 and such that the mobile image 125 is not formed within either of the first tube lens 120 or the second tube lens 130. For example, in an example embodiment, the focal properties of the first tube lens 120 and the relative locations of the first tube lens 120 and the second tube lens 130 are configured such that the mobile image 125 is always formed between the first tube lens 120 and second tube lens 130 and is not formed within either of the first tube lens or the second tube lens. For example, the mobile image 125 is not affected by the imperfections and/or dirt on the surface of a lens of the first tube lens 120 or second tube lens 130.

In various embodiments, the second tube lens 130 forms an aberrated infinity focused image. For example, the second tube lens 130 and the IFPD objective 140 are configured to produce an aberrated wavefront at the upstream surface of the tunable lens 160 that is configured to null and/or cancel out the tuning-induced aberrations.

In various embodiments, at least one of the first tube lens 120 or the second tube lens 130 defines a pupil 135 located between the second tube lens 130 and the IFPD objective 140. In the illustrated embodiment, no optical components are located at the pupil 135. However, in an example embodiment, one or more optical elements may be located and/or disposed at the pupil 135. For example, in an example embodiment, a deformable mirror adaptive optics element or other adaptive optics element is disposed at the pupil. An adaptive optics element is an optics element configured to correct a wavefront by changing the shape of the optical element by applying a control signal (e.g., by the at least one processing element 222 and/or an appropriate driver in communication with the at least one processing element 222) to the adaptive optical element. A deformable mirror adaptive optics element is an adaptive optics element with a controllable reflective surface shape. In an example embodiment, the deformable mirror adaptive optics element or other adaptive optics element is configured to compensate for wavefront aberrations introduced by at least one of a sample object (e.g., disposed in the sample volume 5, as shown in FIG. 7) or the tunable lens 160.

In various embodiments, the tunable optical assembly 100 further comprises a primary objective 110. In various embodiments, the primary objective 110 is selected based on properties regarding the sample to imaged, the sample volume 5, a desired level of magnification of the resulting image, and/or the like. For example, the primary objective 110 may be a water objective, oil objective, air objective, and/or other objective, as appropriate for the application. In various embodiments, the primary objective 110 may be exchangeable. For example, different primary objectives 110 may be used for imaging of different samples. For example, a first sample may be disposed within the sample volume 5 and sampled and/or imaged using a first primary objective 110. The first sample may then be removed from the sample volume, a second sample may be placed in the sample volume, and the second sample may be sampled and/or imaged using a second primary objective 110. In various embodiments, the IFPD objective 140 may be switched when the primary objective 110 is switched. For example, a first IFPD objective 140 having a first magnification may be used when the first primary objective 110 is used and a second IFPD objective 140 having a second magnification (e.g., which is different form the first magnification) may be used when the second primary objective 110 is used. In an example embodiment, the first and second IFPD objectives 140 have different focal lengths. In an example embodiment, the first and second IFPD objectives 140 have the same focal length.

In an example embodiment, a particular IFPD objective 140 may be used with both the first and second primary objectives 110. For example, the particular IFPD objective 140 may be used with a primary objective 110 that is a 30× air objective, a 40× water objective, or a 45× oil objective (wherein the magnifications are given relative to the effective focal length (EFL) of the first tube lens 120) due to simultaneous changes in both the focal length and immersion media of these example primary objectives 110 maintaining a reduced aberration condition. For example, the particular IFPD objective 140 may be used with first and second primary objectives 110 given that the product of the EFL of the first primary objective 110 and the refractive index of the immersion media of the first primary objective 110 is approximately and/or substantially equal to the product of the EFL of the second primary object and the refractive index of the immersion media of the second primary objective.

In various embodiments, the tunable optical assembly 100 further comprises a relay lens 170. In various embodiments, the relay lens 170 is disposed downstream of the tunable lens 160 with respect to the optical path of the tunable optical assembly 100. In various embodiments, the relay lens 170 is a lens or lens assembly configured to correct at least one of a tuning-independent coma or axial color of the tunable optical assembly 100. Thus, the tunable optical assembly 100 may be simultaneously corrected for both tuning-independent aberrations and tuning-induced aberrations.

FIG. 6 provides a schematic view of an example relay lens 170, according to an example embodiment. In the illustrated embodiment, the relay lens 170 comprises a positive singlet 172 made of flint glass, a doublet 174 with a positive element from crown glass and a negative element made from flint glass, a doublet 176 with a positive element made from crown glass and a negative element made from light flint glass, and a doublet 178 with a negative element made from light flint glass and a positive element made from flint glass, in order of the optical path of the tunable optical assembly 100. A light flint glass is a flint glass having a refractive index that is less than approximately 1.62.

In various embodiments, the tunable optical assembly 100 defines an imaging plane 180. For example, at least one of the tunable lens 160 and/or relay lens 170 may define the imaging plane 180. In various embodiments, the tunable optical assembly 100 is configured to form an image at the imaging plane 180. For example, the imaging plane 180 may be disposed at a focal plane of the tunable lens 160 and/or relay lens 170. For example, the imaging plane 180 is an imaging plane of the tunable optical assembly 100. In various embodiments, an optical sensor 190 or an eye piece is disposed and/or located at the imaging plane 180. For example, the optical sensor 190 or eye piece is disposed such that the entrance pupil of the optical sensor or eye piece is located at the imaging plane 180. In various embodiments, the optical sensor 190 is at least one of a camera, a charge-coupled device (CCD) sensor and/or camera, or a complementary metal-oxide-semiconductor (CMOS) sensor and/or camera.

In various embodiments, the IFPD objective 140 is configured to form a diffraction-limited image. In such embodiments, the magnification of the image formed at the imaging plane 180, relative to the sample, is generally in the range of 1.75 to 6 times. In various embodiments, the IFPD objective 140 is configured to produce an aberrated image, the magnification of the image formed at the imaging plane 180 may be any finite number, generally in the range of 1.75 to 200 times, given system requirements regarding coma are appropriately addressed.

### Exemplary Optical System

FIG. 7 illustrates an example embodiment of an optical system 200 comprising an embodiment of a tunable optical assembly 100. In various embodiments, the optical system 200 is an optical system operating with a high numerical aperture with a tunable lens system. In various embodiments, the tunable optical assembly 100 and/or the optical system 200 is apochromatic over the entire axial scanning range. In various embodiments, the optical system 200 is configured to axially-scan a sample volume 5 to generate a three-dimensional image of a sample positioned and/or disposed at least partially within the sample volume 5. In an example embodiment, the optical system 200 is an axially-scanning microscope system or axially-scanning telescope system. In an example embodiment, the optical system 200 is a confocal microscope system. For example, a confocal assembly is disposed at the imaging plane 180 instead of the optical sensor 190. In another example, a scan mirror may be disposed at the pupil 135 upstream of the IFPD objective 140 and a pinhole and photomultiplier tube may be positioned at the imaging plane 180 instead of the optical sensor 190. In various embodiments, the optical system 200 is a photolithography system wherein the optical sensor 190 is replaced with a photomask and light source. In an example embodiment, the optical system 200 is a laser engraving and/or cutting system.

In various embodiments, the optical system 200 comprises a system optical assembly 210. In various embodiments, the system optical assembly 210 comprises a tunable optical assembly 100. For example, the system optical assembly 210 may be a tunable optical assembly 100 and/or the tunable optical assembly 100 may be a sub-assembly of the system optical assembly 210.

In various embodiments, the optical system 200 further comprises a tunable lens driver 230. In various embodiments, the tunable lens driver 230 is operably coupled to the tunable lens 160. For example, in an example embodiment, the tunable lens driver 230 is configured to apply an electric current and/or voltage to the tunable lens 160 to control the focal length of the tunable lens 160. For example, the tunable lens driver 230 is configured to control the focal length of the tunable lens 160 such that the optical system 200 axially-scans the sample volume 5. In various embodiments, axially-scanning the sample volume 5 comprises capturing images of the sample volume 5 at different points along the optical axis 105 defined by the tunable optical assembly 100 or an axis of the sample volume 5. For example, the optical system 200 may capture and/or generate a first image of a first plane within the sample volume 5 that is substantially perpendicular to the optical axis 105, then capture and/or generate a second image of a second plane within the sample volume 5 that is substantially perpendicular to the optical axis 105. The first and second images, and possibly additional captured and/or generated images of additional respective planes within the sample volume 5 that are each substantially perpendicular to the optical axis 105, may be combined to form a three-dimensional image of the sample volume. In an example embodiment, the first and second images, and possibly additional captured and/or generated images, are provided individually for further processing, analysis, and/or the like.

In various embodiments, the optical system 200 further comprises a controller 220. In the illustrated embodiment, the controller 220 comprises at least one processing element 222, memory 224, a communications interface 226, and a user interface 228.

As shown in FIG. 7, in one embodiment, the controller 220 includes or is in communication with the at least one processing element 222 (also referred to as processors, processing circuitry, and/or similar terms used herein interchangeably) that communicate with other elements within the controller 220 via a bus, for example. As will be understood, the at least one processing element 222 may be embodied in a number of different ways. For example, the processing element at least one may be embodied as one or more complex programmable logic devices (CPLDs), microprocessors, multi-core processors, coprocessing entities, application-specific instruction-set processors (ASIPs), microcontrollers, and/or controllers. Further, the processing element at least one may be embodied as one or more other processing devices or circuitry. The term circuitry may refer to an entirely hardware embodiment or a combination of hardware and computer program products. Thus, the processing element at least one may be embodied as integrated circuits, application specific integrated circuits (ASICs), field programmable gate arrays (FPGAs), programmable logic arrays (PLAs), hardware accelerators, other circuitry, and/or the like. As will therefore be understood, the at least one processing element 222 may be configured for a particular use or configured to execute instructions stored in volatile or non-volatile media or otherwise accessible to the processing element at least one. As such, whether configured by hardware or computer program products, or by a combination thereof, the at least one processing element 222 may be capable of performing steps or operations according to embodiments of the present invention when configured accordingly.

In various embodiments, the at least one processing element 222 is configured to control the tunable lens driver 230 to control the focal length of the tunable lens 160. The at least one processing element 222 may further be in communication with and/or control operation of the memory 224, communications interface 226, and/or user interface 228. In various embodiments, the at least one processing element 222 is in communication with the optical sensor 190. For example, the at least one processing element 222 may receive signals from the optical sensor 190 that are processed and/or analyzed (e.g., by the at least one processing element 222) to form the first and second images, and possibly additional captured and/or generated images.

In one embodiment, the controller 220 further includes or is in communication with memory 224. In various embodiments, the memory 224 is configured to store executable instructions and/or the like configured to cause the optical system 200 to capture and/or generate a first image, a second image, and possibly additional captured and/or generated images of planes within the sample volume 5 that are substantially perpendicular to the optical axis 105; generate a three-dimensional image of the sample volume 5 based on the first image, second image, and possibly additional captured and/or generated images; cause the first image, second image, possibly additional captured and/or generated images, and/or the three-dimensional image of the sample volume 5 to be stored in the memory 224, provided (e.g., transmitted) via the communications interface 226, provided (e.g., displayed) via the user interface 228; and/or the like. In an example embodiment, the memory 224 is configured to store the first image, second image, possibly additional captured and/or generated images, and/or the three-dimensional image of the sample volume 5.

In various embodiments, the memory 224 includes non-volatile media (also referred to as non-volatile storage, memory, memory storage, memory circuitry and/or similar terms used herein interchangeably). In one embodiment, the non-volatile storage or memory may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In various embodiments, the memory 224 includes or is in communication with volatile media (also referred to as volatile storage, memory, memory storage, memory circuitry and/or similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the at least one processing element 222. Thus, the databases, database instances, database management systems, data, applications, programs, program modules, scripts, source code, object code, byte code, compiled code, interpreted code, machine code, executable instructions, and/or the like may be used to control certain aspects of the operation of the controller 220 with the assistance of the at least one processing element 222 and operating system.

As indicated, in one embodiment, the controller 220 may also include one or more communications interfaces 226 for communicating with various computing entities, such as by communicating captured and/or generated images, data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the controller 220 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The illustrated embodiment of the controller 220 further includes or is in communication with one or more input elements, such as a keyboard input, a mouse input, a touch screen/display input, motion input, movement input, audio input, pointing device input, joystick input, keypad input, and/or the like. The controller 220 may also include or be in communication with one or more output elements (not shown), such as audio output, video output, screen/display output, motion output, movement output, and/or the like.

In the illustrated embodiment, the controller 220 further comprises a user interface 228 for user interaction. The user interface 228 is in communication with the at least one processing element 222 to provide output to a user, such as a captured and/or generated image, and/or to receive an indication of user input. In various embodiments, the user interface 228 comprises one or more input devices (e.g., soft or hard keyboard, joystick, mouse, interactive elements such as buttons, touch areas, touch screen device, microphone, and/or the like) for receiving user input and one or more output devices (e.g., speakers, display, and/or the like) for providing output to a user. Alternatively or additionally, the controller 220 may comprise user interface circuitry configured to control at least some functions of one or more user interface elements such as a display and, in some embodiments, a speaker, ringer, microphone and/or the like. The processing element and/or user interface circuitry may be configured to control one or more functions of one or more user interface elements through computer program instructions (e.g., software and/or firmware) stored on the memory 224 accessible to the at least one processing element 222.

As will be appreciated, one or more of the controller's 220 components may be located remotely from other controller 220 components, such as in a distributed system. Furthermore, one or more of the components may be combined and additional components performing functions described herein may be included in the controller 220. Thus, the controller 220 can be adapted to accommodate a variety of needs and circumstances. As will be recognized, these architectures and descriptions are provided for exemplary purposes only and are not limiting to the various embodiments.

### Technical Advantages

In general, tunable lenses are helpful in performing volumetric imaging because they allow the focus point of the imaging optical system to be scanned through the sample volume to be imaged. However, tunable lenses tend to introduce aberrations into the optical system that lead to blurry images and/or other system-induced artifacts being present in the resulting image. Various embodiments provide technical solutions to these technical problems. In particular, various embodiments of the present invention provide an IFPD objective 140 configured to define an intermediate focal plane 150 between the IFPD objective 140 and the tunable lens 160. The IFPD objective 140 is configured to cause an image to be formed at the intermediate focal plane 150 with a prescribed magnification such that the tuning-induced spherical and/or chromatic aberration can be eliminated and/or canceled out, at least to the first order, from the resulting image. Moreover, various embodiments produce an intermediate image with prescribed aberrations to further reduce tuning-induced artifacts and comprise a relay lens 170 downstream of the tunable lens 160 configured to cancel these prescribed aberrations. Thus, various embodiments provide tunable optical assemblies 100 and/or optical systems 200 comprising such tunable optical assemblies 100 that are corrected for tuning-independent aberrations and, at least to the first order, for tuning-induced spherical and/or chromatic aberrations. Various embodiments thereby provide technical improvements to the technical field of axially-scanning optical assemblies and/or optical systems. Such tunable optical assemblies and/or optical systems comprising tunable optical assemblies allow for fast volumetric imaging resulting in images that are free of tuning-independent and, at least to the first order, tuning-induced spherical and/or chromatic aberrations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A tunable optical assembly comprising:
a tunable lens; and
an intermediate focal plane defining (IFPD) objective, the IFPD objective disposed upstream of the tunable lens in the tunable optical assembly and configured to define an intermediate focal plane disposed between the IFPD objective and the tunable lens.

2. The tunable optical assembly of claim 1, wherein the IFPD objective is an air objective and produces a magnification at the intermediate focal plane in a range of four to two times.

3. The tunable optical assembly of claim 1, further comprising:
a first tube lens; and
a second tube lens, the first tube lens being upstream of the second tube lens in the tunable optical assembly and the second tube lens being upstream of the IFPD objective in the tunable optical assembly.

4. The tunable optical assembly of claim 3, wherein the first tube lens forms an intermediate image between the first tube lens and the second tube lens.

5. The tunable optical assembly of claim 4, wherein changing of the focal length of the tunable lens causes the intermediate image to shift positions between the first tube lens and the second tube lens and the first tube lens and the second tube lens are configured such that the intermediate image is not formed within either of the first tube lens or the second tube lens.

6. The tunable optical assembly of claim 3, wherein at least one of the first tube lens or second tube lens defines a pupil between the second tube lens and the IFPD objective.

7. The tunable optical assembly of claim 6, further comprising:
a deformable mirror adaptive optics element disposed at the pupil.

8. The tunable optical assembly of claim 7, wherein the deformable mirror adaptive optics element is configured to compensate for wavefront aberrations introduced by at least one of a sample object or the tunable lens.

9. The tunable optical assembly of claim 1, wherein a magnification of the IFPD objective is configured to reduce an aberration introduced by changing a focal length of the tunable lens.

10. The tunable optical assembly of claim 1, wherein an image formed at the intermediate focal plane contains a prescribed magnitude of coma, configured to reduce spherical aberration introduced by changing a focal length of the tunable lens.

11. The tunable optical assembly of claim 1, wherein an image formed at the intermediate focal plane contains a prescribed magnitude of chromatic aberration, configured to reduce additional chromatic aberration introduced by changing a focal length of the tunable lens.

12. The tunable optical assembly of claim 1, further comprising:
a relay lens disposed downstream of the tunable lens.

13. The tunable optical assembly of claim 12, wherein the relay lens is configured to correct tuning-independent aberrations of the tunable optical assembly.

14. The tunable optical assembly of claim 12, further comprising at least one of an optical sensor or an eye piece disposed at an imaging plane defined by the relay lens.

15. An optical system comprising:
a tunable optical assembly comprising:
a tunable lens; and
an intermediate focal plane defining (IFPD) objective, the IFPD objective disposed upstream of the tunable lens in the tunable optical assembly and configured to define an intermediate focal plane disposed between the IFPD objective and the tunable lens.

16. The optical system of claim 15, further comprising a tunable lens driver configured to control the focal length of the tunable lens.

17. The optical system of claim 16, wherein the focal length of the tunable lens is configured to be adjusted to scan through a sample volume.

18. The optical system of claim 15, wherein an optical sensor located at the imaging plane of the tunable optical assembly is in communication with at least one processing element.

19. The optical system of claim 16, wherein the at least one processing element is configured to control the tunable lens driver.

20. The optical system of claim 15, wherein the optical system is an axially-scanning microscope system, an axially-scanning telescope system, a confocal microscope system, a photolithography system, or a laser cutting and/or engraving system.
